(19) United States
(12) Patent Application Publication
(10) Pub. No.: US 2010/0171884 A1
(43) Pub. Date: Jul. 8, 2010

(54) Video processing apparatus

(75) Inventor: Tomoyuki Saitou, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 12/654,244

(22) Filed: Dec. 15, 2009

(30) Foreign Application Priority Data
Jan. 8, 2009 (JP) 2904/2009

(51) Int. Cl. H04N 5/202

(52) U.S. Cl. 348/674; 348/E05.074

(57) ABSTRACT

A final-correction-value acquisition unit performs, for each frame, reduction processing for reducing a difference in gamma correction value between frames and thereby acquires a final correction value of the frame. The final-correction-value acquisition unit determines into which type an observed frame is classified among a first-, a second- and a third-type frames, and controls a level of the reduction processing on the observed frame according to a determined type of the observed frame, the first-type frame being a frame having a change amount obtained from a change-amount calculator equal to or smaller than a predetermined threshold, the second-type frame being a frame having a change amount larger than the threshold and at least one frame having a change amount larger than the threshold exists within a preceding predetermined period immediately before the observed frame, the third-type frame being a frame other than the first- and second-type frames.

### BACKGROUND OF THE INVENTION

1. Field of the Invention

The present invention relates to video processing, and in particular relates to tone correction for a video signal.

2. Description of the Related Art

Tone correction for enhancing video quality is performed by an apparatus for playing back and displaying video signals, and various techniques have been proposed for the tone correction.

For example, a technique disclosed in Japanese Patent Application Publication No. 2008-134277 is a technique for performing tone correction by the following steps. Firstly, a scene change in a video signal is detected. Then, a luminance histogram of each of frames is acquired for each scene to determine characteristics (corresponding to content characteristics described in JP-A 2008-134277) for the scene. Thereafter, a gamma correction value is calculated so that a tone pattern can match the determined characteristics, thereby resulting in a tone correction.

In a technique disclosed in Japanese Patent Application Publication No. 2006-270417, a gamma correction value obtained for each frame of a video signal is processed by an IIR filter and then used as a final correction value. In order to obtain the final correction value, a variation value which is an index of a scene change is obtained based on a histogram of the video signal and on a luminance characteristic amount such as an average luminance value, and then a control is performed so that the response speed of the IIR filter would be increased with the increase of the variation value.

According to the technique disclosed in JP-A 2006-270417, when the variation value is small, that is, when there is a low possibility that a scene change is included, the response speed of the IIR filter is low. Accordingly, a difference in the final correction value between an observed frame, which is a processing target frame, and the frame preceding the observed frame in the same scene is reduced, thus resulting in obtaining an effect of playing back and displaying in which a feeling something wrong with the scene is alleviated as compared to the technique in JP-A 2008-134277. Furthermore, when the variation value is large, that is, when there is a high possibility that a scene change is included, the response speed of the IIR filter is high. Accordingly, the final correction value of the observed frame is unlikely to be affected by the final correction value of the frame showing a different scene. Thus, also in a case where a scene change is included, an optimum correction result can be obtained.

As described in JP-A 2008-134277 and JP-A 2006-270417, a scene change in a video signal is generally detected based on the level of an amount of change in luminance characteristics in a histogram of a frame, or the like. For example, in the technique in JP-A 2006-270417, the response speed of the IIR filter is controlled by taking the level of the amount of change as the possibility of a scene change.

Meanwhile, a large amount of change described above is not necessarily attributable to a scene change. For example, in a case of a high-speed fade-in or fade-out, there is a large amount of change in luminance characteristics in the histogram or the like between frames, although the frames are of the same scene. In the technique in JP-A 2006-270417, the response speed of the IIR filter is increased with the increase of the amount of change. Accordingly, when the technique is used for the gamma correction values of such frames, the difference in gamma correction value between the frames is not reduced sufficiently, so that the result of playing back and displaying might involve a feeling something wrong with the frames.

### SUMMARY

An aspect of the present invention is a video signal processing apparatus. The video signal processing apparatus includes: a correction value calculator that calculates, for each frame of a video signal, a gamma correction value for performing a tone correction on the frame, on the basis of an amount of luminance characteristic of the frame; a change-amount calculator that calculates, for each frame, an amount of change in luminance characteristic between frames, the amount of change capable of being used an index value for determining a scene change; and a final-correction-value acquisition unit that performs, for each frame, reduction processing for reducing a difference in the gamma correction value between frames and thereby acquires a final correction value of the frame.

The final-correction-value acquisition unit determines into which type an observed frame is classified among a first type, a second type and a third type, and controls a level of the reduction processing on the observed frame according to the determined type of the observed frame, the first type being a frame having an amount of change equal to or smaller than a predetermined threshold, the second type being a frame having an amount of change larger than the threshold and at least one frame having an amount of change larger than the threshold exists within a predetermined period immediately before the observed frame, the third type being a frame other than the first type and the second type.

Note that an aspect expressed by replacing the apparatus according to the foregoing aspect by a method, a system or the like is effective as an aspect of the present invention.

Additionally, also effective is a program causing a computer to execute processing performed by the apparatus or part of the apparatus.

According to the aspect of the present invention, an appropriate tone correction can be performed on a video signal in which there is a large amount of change in luminance characteristics between frames although the frames are of the same scene.

### BRIEF DESCRIPTION OF THE DRAWINGS

FIG. 1 is a diagram showing a tone correction circuit 100 according to an embodiment of the present invention.

FIG. 2 is a graph showing an example of a histogram of a frame.

FIG. 3 is a graph for explaining processing performed by a gamma correction-value calculator. (No. 1)

FIG. 4 is a graph for explaining processing performed by the gamma correction-value calculator. (No. 2)

FIG. 5 is a graph showing an example of gamma correction values obtained by the gamma correction-value calculator.

### DESCRIPTION OF THE PREFERRED EMBODIMENT

An embodiment of the present invention will be described below with reference to the drawings. For clarification, the description below and drawings are subjected to omission or simplification as appropriate. Moreover, each of components shown as a functional block for various processing in the drawings can be configured as hardware by a CPU, a memory, or other circuit, and can be implemented as software by a program loaded onto a memory, or the like. Accordingly, it should be understood by those skilled in the art that these functional blocks can be implemented in various forms such as hardware only, software only, and a combination thereof. The implementation is not limited to any of these.

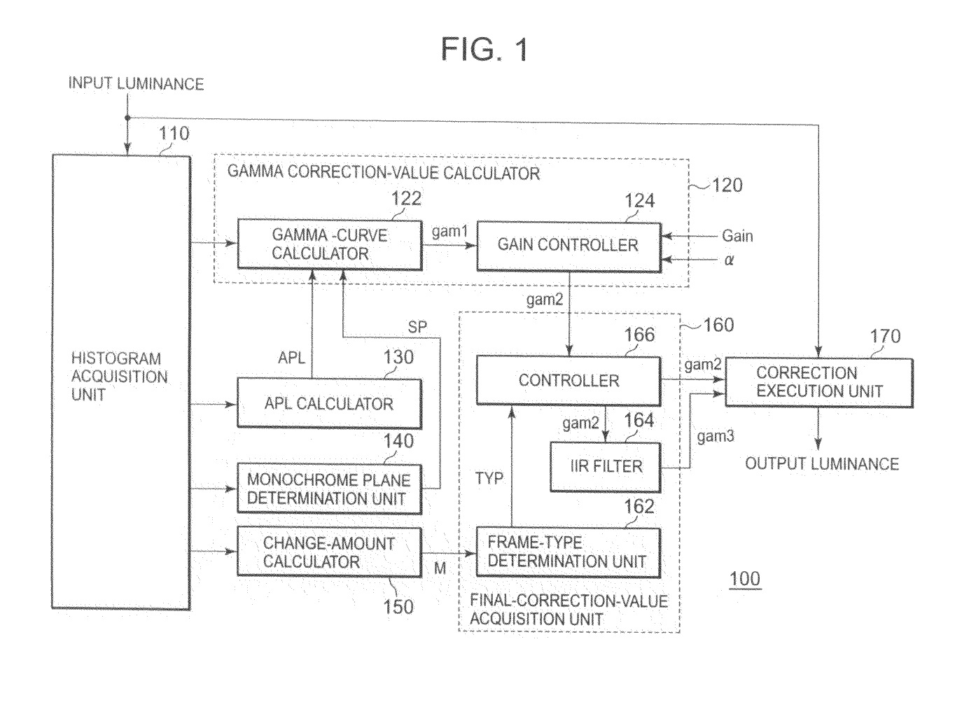

FIG. 1 shows a tone correction circuit 100 according to the embodiment of the present invention. The tone correction circuit 100 is provided in an apparatus for playing back and displaying video signals and performs a tone correction on a video signal. As shown in FIG. 1, the tone correction circuit 100 includes a histogram acquisition unit 110, a gamma correction-value calculator 120, an average picture level (APL) calculator 130, a monochrome plane determination unit 140, a change-amount calculator 150, a final-correction-value acquisition unit 160 and a correction execution unit 170.

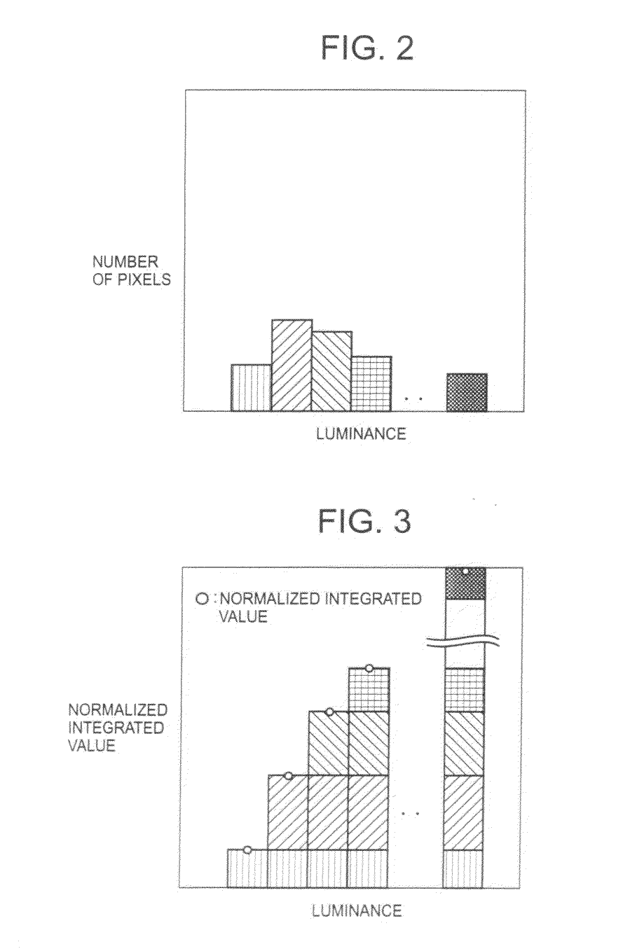

The histogram acquisition unit 110 receives an input of a luminance of a video signal and acquires a histogram for each of frames. FIG. 2 shows an example of the histogram acquired by the histogram acquisition unit 110.

As shown in FIG. 2, the horizontal axis of the histogram represents luminance, while the vertical axis represents the number of pixels. In FIG. 2, bars in different patterns are used to represent bins respectively showing luminance values, and the height of each of the bars represents the number of pixels of the corresponding bin.

The histogram acquisition unit 110 acquires a histogram for each frame sequentially and then outputs the histogram to the gamma correction-value calculator 120, the APL calculator 130, monochrome-plane determination unit 140 and the change-amount calculator 150.

The APL calculator 130 calculates an APL of a currently observed frame by using the histogram acquired by the histogram acquisition unit 110, and then outputs the calculation result to the gamma correction-value calculator 120.

The monochrome-plane determination unit 140 determines whether or not the observed frame is a monochrome plane such as a title screen, and then outputs a signal SP showing the determination result to the gamma correction-value calculator 120. Hereinafter, the signal SP is referred to as a monochrome plane determination signal SP. When the percentage of the sum of pixels plotted at a peak and around the peak in the histogram of the observed frame reaches or exceeds a predetermined percentage (for example, ¾) of the total number of pixels of the observed frame, the monochrome-plane determination unit 140 determines the observed frame as a monochrome plane.

The change-amount calculator 150 calculates an amount of change M in luminance characteristics of the observed frame, and then outputs the amount of change M to the final-correction-value acquisition unit 160. The amount of change M could be used as an index value of a scene change. In this embodiment, the change-amount calculator 150 calculates an amount of change between histograms of a frame preceding the observed frame and the observed frame, as the amount of change M. Specifically, the amount of change is a total sum of absolute values each representing a difference between the observed frame and the preceding frame thereof with respect to each bin.

The gamma correction-value calculator 120 is provided to obtain a gamma correction value used for a tone correction to enhance contrast, and includes a gamma-curve calculator 122 and a gain controller 124.

The gamma-curve calculator 122 calculates a gamma correction value gam1 of the observed frame on the basis of the histogram, the APL and the monochrome plane determination signal SP of the observed frame, and then outputs the gamma correction value gam1 to the gain controller 124.

Specifically, when the monochrome plane determination signal SP relevant to the observed frame shows that the observed frame is a monochrome plane, the gamma-curve calculator 122 outputs a linear coefficient as the gamma correction value gam1 to the gain controller 124. The linear coefficient is a correction value showing that “output luminance=input luminance,” that is, a correction is not to be performed.

On the other hand, when the monochrome plane determination signal SP relevant to the observed frame shows that the observed frame is not a monochrome plane, the gamma-curve calculator 122 firstly obtains an cumulated value for the histogram of the observed frame by integrating the number of pixels at each of control points (luminance) to be used in execution of a tone correction by the correction execution unit 170. The gamma-curve calculator 122 then normalizes the thus obtained cumulated values by using the maximum value of the dynamic range (for example, 1023 for a 10-bit luminance signal). FIG. 3 shows normalized cumulated values (white dots in FIG. 3) obtained by the gamma-curve calculator 122 on the basis of the histogram taken as the example shown in FIG. 2. Note that, also in FIG. 3, the height of each bar representing a corresponding one of the bins shows the number of pixels, and the pattern of the bar representing the corresponding bin matches the pattern in FIG. 2.

Subsequently, the gamma-curve calculator 122 calculates the gamma correction value gam1 according to the following Expression (1) by using the normalized cumulated value (hereinbelow referred to as Pval) and the APL obtained by the APL calculator 130.

gam1=((PLmax−APL)×Ppoint×Pval+APL'D)/PLmax/D (1)

In Expression (1), “PLmax” is the maximum value of an APL. For example, when the APL is expressed in 128 levels, the APL takes a value in a range from 0 to 127 and the PLmax is 127.

Additionally, “Ppoint” is a luminance value at a control point, and “D” is the maximum value of the dynamic range of the luminance. For example, in the case of a 10-bit luminance signal, “D” is 1023.

As learned from the foregoing explanation, the gamma correction value gam1 represents an output luminance in a case where the luminance at a control point is taken as an input luminance, and accordingly includes a luminance at the control point and an output luminance which are paired with each other. However, for convenience of explanation, the luminance at the control point and output luminance are collectively referred to as the gamma correction value gam1.

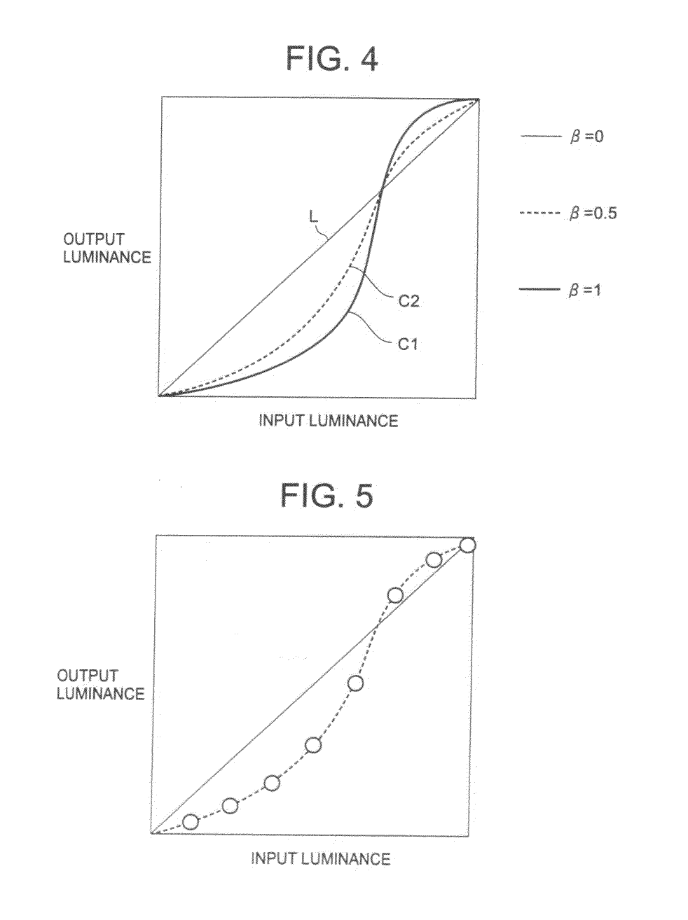

A curve C1 in FIG. 4 is a gamma curve representing an example of the gamma correction value gam1 obtained by the gamma-curve calculator 122. In a monochrome plane, the gamma correction value gam1 to be outputted by the gamma-curve calculator 122 corresponds to a line L.

The gain controller 124 performs a gain control on the gamma correction value gam1 obtained by the gamma-curve calculator 122 so as to prevent an excessive correction. Specifically, according to Expressions (2) and (3) using a preset gain coefficient (Gain) and a coefficient α, the gain controller 124 obtains a gamma correction value gam2 from the gamma correction value gam1.

β=Gain−(Σ|gam1−L|)/α (2)

gam2=L+(gam1−L)×β (3)

In Expression (2), “Σ|gam1−L|” is a total sum of absolute values at all the control points, the absolute values each showing a difference between a value on the line L and a gamma correction value gam1 at a control point. As learned from Expression (3), with the decrease of β obtained by Expression (2), the gamma correction value gam2 approaches the gamma correction value corresponding to the line L. By contrast, with the increase of β, the gamma correction value gam2 approaches the gamma correction value gam1. When the result obtained by Expression (2) is equal to or less than “0, ” β is set to “0,” and thereby the gamma correction value gam2 corresponds to a linear coefficient in order to prevent a correction in a reverse direction.

A curve C2 in FIG. 4 shows a curve representing a gamma correction value gam2 obtained from the gamma correction value gam1 where β is 0.5. Where β is 1, C2 based on the gamma correction value gam2 matches C1 based on the gamma correction value gam1.

FIG. 5 shows an example of gamma correction values gam2 (white dots in FIG. 5) obtained by the gain controller 124. The gamma correction value gam2 is also an output luminance corresponding to a luminance at each control point. The gain controller 124 outputs the thus obtained gamma correction value gam2 of the observed frame to the final-correction-value acquisition unit 160.

The final-correction-value acquisition unit 160 acquires a final correction value, which is to be outputted to the correction execution unit 170, on the basis of the gamma correction value gam2. The final-correction-value acquisition unit 160 includes a frame-type determination unit 162, a leaky integrator circuit, that is, an IIR filter 164 used here as an example, and a controller 166.

The frame-type determination unit 162 determines the type of the observed frame on the basis of the amount of change M outputted from the change-amount calculator 150, and then outputs the determination result to the controller 166. In this embodiment, when determining the type of the observed frame, the frame-type determination unit 162 refers to the amount of change M of a frame existing within a predetermined period before the observed frame. For this reason, the frame-type determination unit 162 stores, among frames which have been subjected to determination, the amount of change M of the frame existing within the predetermined period mentioned above. The predetermined period will be described in detail later.

When the observed frame has an amount of change M equal to or smaller than a predetermined threshold, the frame-type determination unit 162 determines the observed frame as a first-type frame. The first-type frame corresponds to a frame causing no scene change.

When the observed frame has an amount of change M larger than the threshold and at the same time a frame having an amount of change M larger than the threshold exists in the predetermined period immediately before the observed frame, the frame-type determination unit 162 determines the observed frame as a second-type frame.

When the observed frame is not classified into any one of the first-type and second type frames, the frame-type determination unit 162 determines the observed frame as a third-type frame.

Having an amount of change M larger than the threshold, the third-type frame corresponds to a frame causing a scene change.

Meanwhile, the second-type frame also has the amount of change M larger than the threshold, but, in this embodiment, is determined as a different-type frame from the third-type frame, i.e., a frame having a changed scene. This is because, as described above, whether or not a frame having an amount of change M larger than the threshold exists in the preceding predetermined period has been added as a determination condition.

The controller 166 performs controls on output of a final correction value to the correction execution unit 170 and on the response speed of the IIR filter 14. The final correction value is any one of: the gamma correction value gam2 obtained by the gain controller 129 based on the determination result of the frame-type determination unit 162; and a result (referred to as a gamma correction value gam3 below) of processing by the IIR filter 164 performed on the gamma correction value gam2 outputted to the IIR filter 164.

Specifically, when a frame-type determination signal TYP outputted from the frame-type determination unit 162 shows that the observed frame is the first-type frame, the controller 166 outputs the gamma correction value gam2 of the observed frame to the IIR filter 164. As the result, the gamma correction value gam3 obtained from the gamma correction value gam2 by the IIR filter 164 is outputted as the final correction value to the correction execution unit 170.

The first-type frame is a frame causing no scene change. Accordingly, when the result obtained by processing the gamma correction value gam2 of the first-type frame through the IIR filter 164 is used as the final correction value, a difference from the correction value of the preceding frame is reduced. Consequently, an effect of playing back and displaying in which a feeling something wrong is alleviated can be obtained.

When the frame-type determination signal TYP shows that the observed frame is the third-type frame, the controller 166 outputs the gamma correction value gam2 of the observed frame to the correction execution unit 170 without changing the value. The significance of processing in this way will be described later.

The third-type frame is a frame having a changed scene. For the frame, the gamma correction value gam2 is used as the final correction value without any processing, and thus the final correction value of the observed frame is not affected by the correction value of the preceding frame. Consequently, an effect of playing back and displaying in which a scene change is clearly identified can be obtained.

When the frame-type determination signal TYP shows that the observed frame is the second-type frame, the controller 166 outputs the gamma correction value gam2 of the observed frame to the IIR filter 164 while decreasing the response speed of the IIR filter 164 as compared to the case of the first-type frame.

The correction execution unit 170 performs a tone correction on the observed frame by using the final correction value (gamma correction value gam2 or gamma correction value gam3) of the observed frame outputted from the final-correction-value acquisition unit 160, thereby obtaining the output luminance.

As described above, a fade-in or a fade-out results in a large amount of change in luminance characteristics between frames, although the frames are of the same scene. In a conventional technique in which a scene change is determined based on only the amount of change between frames, such a frame having a large amount of change is determined as a frame having a changed scene. In order to distinguish such a frame from a frame having a changed scene, the inventor of the patent application has established a technique by which the type of frame is determined based on not only the amount of change but also whether or not a frame having a large amount of change exists in a predetermined period before the observed frame. The second-type frame determined by the frame-type determination unit 162 corresponds to a frame in which there is a large amount of change between frames although the frames are of the same scene. The third-type frame corresponds to a frame having a changed scene.

The length of the “predetermined period” is set based on an empirical value or the frame rate so that, when a frame having an amount of change larger than the threshold exists in the predetermined period, the observed frame can be determined as the second-type frame. For example, in a case where the frame rate is 60 Hz, the length may be set at approximately 20 seconds.

In this embodiment, when the observed frame has the amount of change M larger than the threshold and at the same time a frame having the amount of change larger than the threshold exists within the predetermined period before the observed frame, the observed frame is determined as the second-type frame. Alternatively, for example, when the observed frame has the amount of change M larger than the threshold and at the same time an appearance frequency of such a frame as mentioned above existing in the predetermined period exceeds a threshold, the observed frame may be determined as the second-type frame. In this case, the length of the predetermined period may be set longer.

In summary, in this embodiment, for the frame featuring a fade-in or fade-out (second-type frame), a result obtained by processing the gamma correction value gam2 of the second-type frame through the IIR filter 164 is used as the final correction value. Thereby, an effect of fplaying back and displaying in which a feeling something wrong is alleviated can be obtained in the case of the frame showing such a scene.

Furthermore, since the response speed of the IIR filter 164 for the second-type frame is set lower than for the first-type frame, the difference from the correction value of the preceding frame is reduced more in the case of the observed frame of the first time than in the case of the observed frame of the first type. Consequently, a feeling something wrong in playing back and displaying the frame can be alleviated further.

In this embodiment, for example, the amount of change in the histogram is used to determine the type of a frame. However, the determination may be made by use of an amount of change in other luminance characteristics such as an average luminance, a combination of amounts of changes in multiple luminance characteristics, or the like.

Meanwhile, for the third-type frame, the gamma correction value gam2, which is obtained by the gamma correction-value calculator 120, is used as the final correction value without any processing. For example, for the gamma correction value gam2 of the third-type frame, a result of processing of the gamma correction value gam2 by the IIR filter having a higher response speed than for the first-type frame may be used as the final correction value. In this case, the response speed of the IIR filter maybe set constant when the third-type frame is processed. Alternatively, the response speed of the IIR filter may be increased with the increase of the amount of change M.

It goes without saying that the response speed of the IIR filter may be the same as that for the first-type frame when the second-type frame is processed.

Although the invention has been described above in connection with several preferred embodiments thereof, it will be appreciated by those skilled in the art that those embodiments are provided solely for illustrating the invention, and should not be relied upon to construe the append claims in a limiting sense.

What is claimed is:

1. A video signal processing apparatus comprising:
a correction value calculator that calculates, for each frame of a video signal, a gamma correction value for performing a tone correction on the frame, on the basis of an amount of luminance characteristic of the frame;
a change-amount calculator that calculates, for each frame, an amount of change in luminance characteristic between frames, the amount of change capable of being used an index value for determining a scene change; and
a final-correction-value acquisition unit that performs, for each frame, reduction processing for reducing a difference in the gamma correction value between frames and thereby acquires a final correction value of the frame, wherein
the final-correction-value acquisition unit determines into which type an observed frame is classified among a first type, a second type and a third type, and controls a level of the reduction processing on the observed frame according to the determined type of the observed frame, the first type being a frame having an amount of change equal to or smaller than a predetermined threshold, the second type being a frame having an amount of change larger than the threshold and at least one frame having an amount of change larger than the threshold exists within a predetermined period immediately before the observed frame, the third type being a frame other than the first type and the second type.

2. The video signal processing apparatus according to claim 1, wherein the final-correction-value acquisition unit controls the level of the reduction processing within a range including not performing the reduction processing.

3. The video signal processing apparatus according to claim 1, wherein
the final-correction-value acquisition unit includes:
a leaky integrator circuit to which the gamma correction value is inputted;
a frame-type determination unit that determines into which type an observed frame is classified among the first type, the second type and the third type; and
a controller that performs at least one of a control on a response speed of the leaky integrator circuit and a control on a final correction value by selecting any one of an output value from the leaky integrator circuit and the gamma correction value, in accordance with the type of the observed frame determined by the frame-type determination unit.

4. The video signal processing apparatus according to claim 3, wherein the controller performs the control on the final correction value so that
for a frame of any one of the first type and the second type, the output value from the leaky integrator circuit is used as the final correction value, and
for a frame of the third type, the gamma correction value is used as the final correction value.

5. The video signal processing apparatus according to claim 4, wherein the controller performs the control on the response speed of the leaky integrator circuit so that the response speed for a frame of the second type is lower than that for a frame of the first type.

6. The video signal processing apparatus according to claim 3, wherein
the controller performs the control on the response speed of the leaky integrator circuit so that
for a frame of any one of the first, second and third types, the output value from the leaky integrator circuit is used as a final correction value,
for a frame of a type other than the second type, the response speed is increased with the increase of the amount of change, and
for a frame of the second type, the response speed is set lower than the lowest response speed for the frame of any one of the types other than the second type.

7. The video signal processing apparatus according claim 1, wherein the amount of luminance characteristic is represented by a luminance histogram.
